(19) United States
(12) Patent Application Publication
(10) Pub. No.: US 2018/0365314 A1
(43) Pub. Date: Dec. 20, 2018

(54) Method and Device for Automatically Determining Decision in Judgment Document

(71) Applicant: BEIJING GRIDSUM TECHNOLOGY CO., LTD., Beijing (CN)

(72) Inventors: Bin HU, Beijing (CN); Weifu CUI, Beijing (CN)

(73) Assignee: BEIJING GRIDSUM TECHNOLOGY CO., LTD., Beijing (CN)

(21) Appl. No.: 15/780,627

(22) PCT Filed: Nov. 10, 2016
(86) PCT No.: PCT/CN2016/105273

§ 371 Date: May 31, 2018

(30) Foreign Application Priority Data
Dec. 1, 2015 (CN) 201510866865.0

(51) Int. Cl. G06F 17/30; G06F 17/27; G06Q 50/18

(52) U.S. Cl. CPC G06F 17/30616; G06Q 50/18; G06F 17/2765

(57) ABSTRACT

The present invention provides a method and device for automatically determining a decision in a judgment document, relates to the field of natural language processing, and solves the problem of low efficiency in manually extracting a judgment decision. The method comprises: traversing a preset marker 1 and marker 2 in the judgment document, the marker 1 being a phrase ‘decided as follows’, ‘decision as follows’ or a variation thereof, and the marker 2 being a phrase ‘acceptance fee’ or a variation thereof; extracting a judgment paragraph between the marker 1 and the marker 2, the judgment paragraph involving a judgment decision; in the judgment paragraph, looking up a lost-lawsuit related keyword within a preset character range posterior to the marker 1, the lost-lawsuit related keyword involving a word ‘reject’, ‘prohibit’ or a variation thereof; and if the lost-lawsuit related keyword is found, determining the decision as losing the case. The present invention is mainly used in the process of automatically determining a decision of a judgment document written in Chinese.

This application is based on the Chinese patent application No. 201510866865.0 filed on Dec. 1, 2015, and claims the priority of this Chinese patent application, the entire content of which is incorporated herein by reference.

### TECHNICAL FIELD

The present invention relates to the field of natural language processing, in particular to a method and device for automatically determining a decision in a judgment document.

### BACKGROUND ART

A judgment document is a legally binding judicial document made, in terms of proceedings of cases and substantive rights and obligations of litigants, by people's courts exerting state jurisdiction, based on the confirmation of litigation facts of the litigants and the laws, regulations and judicial interpretation concerned, at the termination of the trial procedures.

For judicial departments and lawyers, judgment documents are other references than laws and regulations. Generally, decisions stated in judgment documents of similar cases in the past are used as reference to determine a decision of a current case, or determine the possibility of winning the current case.

In the prior art, the search and extraction of a decision in a judgment document of a case are conducted manually. There are a huge amount of judgment documents, and manual search is labor-consuming and time-consuming and may cause missing detection.

### SUMMARY OF THE INVENTION

The present invention provides a method and device for automatically determining a decision in a judgment document, to solve the problem of low efficiency in manually extracting a judgment decision.

In order to solve the technical problem, on one hand, the present invention provides a method for automatically determining a decision in a judgment document, and the method comprises:

traversing a preset marker 1 and marker 2 in the judgment document, the marker 1 being a phrase ‘decided as follows’, ‘decision as follows’ or a variation thereof, the marker 2 being a phrase ‘acceptance fee’ or a variation thereof;

extracting a judgment paragraph between the marker 1 and the marker 2, the judgment paragraph involving a judgment decision;

in the judgment paragraph, looking up a lost-lawsuit related keyword within a preset character range posterior to the marker 1, the lost-lawsuit related keyword involving a word ‘reject’, ‘prohibit’ or a variation thereof;

and if the lost-lawsuit related keyword is found, determining the decision as losing the case.

On the other hand, the prevent invention provides a device for automatically determining a decision in a judgment document, and the device comprises:

a traversing unit, used for traversing a preset marker 1 and marker 2 in the judgment document, the marker 1 being a phrase ‘decided as follows’, ‘decision as follows’ or a variation thereof, and the marker 2 being a phrase ‘acceptance fee’ or a variation thereof;

an extraction unit, used for extracting a judgment paragraph between the marker 1 and the marker 2, the judgment paragraph involving a judgment decision;

a look-up unit, used for looking up a lost-lawsuit related keyword within a preset character range posterior to the marker 1 in the judgment paragraph extracted by the extraction unit, the lost-lawsuit related keyword involving a word ‘reject’, ‘prohibit’ or a variation thereof;

and a determining unit, used for determining the decision as losing the case if the lost-lawsuit related keyword is found.

The method and device for automatically determining a decision in a judgment document provided by the invention can traverse the preset markers in the judgment document, extract the paragraph related to the decision, then look up the lost-lawsuit related keyword and finally determine whether the decision is losing the case. Compared with the prior art, the method and device of the invention can automatically determine a judgment decision, thereby reducing manual workload, saving labor and improving the efficiency of extracting a judgment decision.

The above description is merely an overview of the technical solution of the present invention, in order to clearly understand the technical solution of the present invention, the implementation is carried out according to the context of the description, and the particular embodiments of the invention will be described below, from which the foregoing descriptions and other objects, features and advantages of the invention will be evident.

### BRIEF DESCRIPTION OF THE DRAWINGS

From the following detailed description of preferred embodiments, other features and advantages of the invention will be understood more clearly for those skilled in the art. The accompanying drawings are intended to illustrate preferred embodiments but not to limit this invention. Through the drawings, like numbers indicate like elements. In the drawings:

FIG. 1 shows a flowchart of a method for automatically determining a decision in a judgment document provided by an embodiment of the invention;

FIG. 2 shows a flowchart of another method for automatically determining a decision in a judgment document provided by an embodiment of the invention;

FIG. 3 shows a flowchart of still another method for automatically determining a decision in a judgment document provided by an embodiment of the invention;

FIG. 4 shows a block diagram of composition of a device for automatically determining a decision in a judgment document provided by an embodiment of the invention;

FIG. 5 shows a block diagram of composition of another device for automatically determining a decision in a judgment document provided by an embodiment of the invention.

### DETAILED DESCRIPTION OF THE INVENTION

The exemplary embodiments of the disclosure will be described below in details with reference to the accompanying drawings. Although the exemplary embodiments of the disclosure are shown in the accompanying drawings, it should be noted that the disclosure may be embodied in various modes and not intended to be limited by the embodiments described herein. Rather, these embodiments are provided to clearly understand the disclosure and give those skilled in the art with the scope of the disclosure completely.

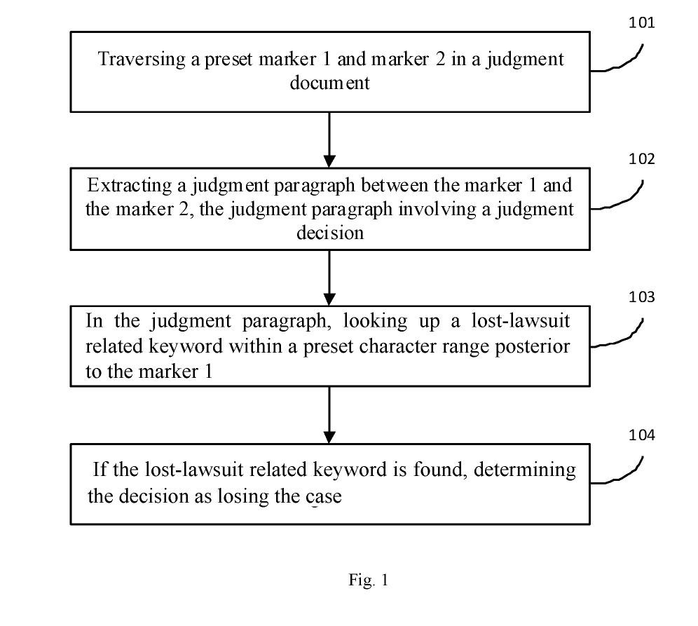

The prevent invention provides a method for automatically determining a decision in a judgment document, as shown in FIG. 1, and the method comprises:

101. Traverse a preset marker 1 and marker 2 in the judgment document.

The judgment document is saved in the form of an electronic text, to facilitate the recognition by a machine. The judgment document may be one obtained from a website and recorded in the form of an electronic text, or recorded in the form of an image, or recorded on paper. The judgment document may be not in the form of an electronic text, and converted to an electronic text by scanning, text recognition and the like. In this embodiment, the initial record form of the judgment document is not limited.

The judgment document carries proceedings and results of people's courts and serves as the only proof of decisions and assignments on substantive rights and obligations of litigants given by people's courts. The outcome of judgment on a case includes a judgment decision of the case and a case acceptance fee. The phrase ‘decided as follows’, ‘decision as follows’ or a variation thereof is used as a marker for the determination of the decision of the judgment document. Posterior to the phrase ‘decided as follows’ or ‘decision as follows’, the judgment decision section and acceptance fee section are followed. The phrase ‘acceptance fee’ or a variation thereof is used to indicate the expense paid by case litigants to people's courts. Thus, the keyword ‘decided as follows’, ‘decision as follows’ or a variation thereof is used as marker 1, and the keyword ‘acceptance fee’ or a variation thereof is used as marker 2.

As used herein, the term ‘variation’ refers to another form of expression having the same meaning. The marker 1 refers to the keyword ‘decided as follows’ or ‘decision as follows’ and its variations have the same meaning as the keyword ‘decided as follows or decision as follows’, and the marker 2 refers to the keyword ‘acceptance fee’ and its variations have the same meaning as the keyword ‘acceptance fee’.

102. Extract a judgment paragraph between the marker 1 and the marker 2, the judgment paragraph involving a judgment decision.

The marker 1 and marker 2 are described in detail in Step 101, and the acceptance fee section is given posterior to the description of judgment decision in the judgment document. Since the section between the marker 1 and the marker 2 comprises the judgment decision, the paragraph of decision section having the judgment decision is extracted, to facilitate the determination of judgment decision via the paragraph

103. In the judgment paragraph, look up a lost-lawsuit related keyword within a preset character range posterior to the marker 1.

In the decision section paragraph extracted in Step 102, a lost-lawsuit related keyword is looked up. The lost-lawsuit related keyword involves a completely negative word, for example, a word ‘reject’, ‘prohibit’ or a variation thereof, A certain situation or event is defined by means of complete negation, to indicate that such situation or event is denied absolutely. Thus, the word ‘reject’, ‘prohibit’ or a variation thereof is used as the lost-lawsuit related keyword.

The term ‘preset character’ refers to a paragraph that is a section located between two line breaks, the line break serving as a marker. Posterior to the marker 1, a paragraph that is located between a first line break and a second line break is used as the area within which the lost-lawsuit related keyword is looked up.

104. If the lost-lawsuit related keyword is found, determine the decision as losing the case.

Based on the result from Step 103, if the lost-lawsuit related keyword is found, the decision is determined as losing the case. In this embodiment, the number of lost-lawsuit related keywords is not limited.

The following judgment document is taken as an example.

Upon handling the disputes over the contract between the plaintiff Liang Xuefang and the defendant the board of the Xinya Restaurant of certain city, both the plaintiff and the defendant are willing to solve it by internal coordination and withdraw the case, and the court makes the following decisions in accordance with the provisions of Article 52 and Article 131 of the Civil Procedure Law of the People's Republic of China,

The prosecution from the plaintiff Liang Fang is rejected.

The acceptance fee of 2,200 RMB and other case charges of 2,200 RMB, totally 4,400 RMB, are borne by the plaintiff.

In the judgment document, the marker 1 ‘decided as follows’, the marker 2 ‘acceptance fee’ are found, the paragraph (involving the phrase ‘the plaintiff Liang Fang is allowed to withdraw the prosecution) that is located between the marker 1 and the marker 2 is extracted, the lost-lawsuit related keyword ‘reject’ and ‘prohibit’ are looked up in the paragraph, and if the lost-lawsuit related keyword is found in the paragraph, the decision of losing the case is determined.

The method for automatically determining a decision in a judgment document, provided by the embodiments of the invention, can traverse the preset markers in the judgment document, extract the paragraph related to the decision, then look up the lost-lawsuit related keyword and finally determine whether the decision is losing the case. Compared with the prior art, the method of the embodiments of the invention can automatically determine judgment decisions, to reduce manual workload, save labor and improve the efficiency of extracting judgment decisions.

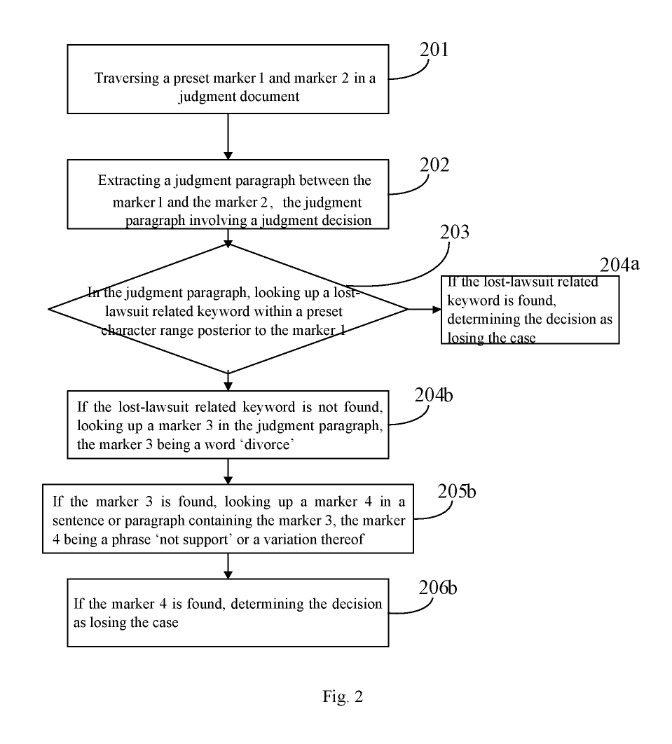

Further, as a detailed and modified mode of the method of FIG. 1, another embodiment of the invention also provides a method for automatically determining a decision in a judgment document, shown in FIG. 2, and the method comprises:

201. Traverse a preset marker 1 and marker 2 in the judgment document.

The marker 1 and marker 2 are traversed in the judgment document in the form of an electronic text, to determine the locations of the marker 1 and marker 2. The marker 1 is a phrase ‘decided as follows’, ‘decision as follows’ or a variation thereof, and the marker 2 is a phrase ‘acceptance fee’ or a variation thereof. In the judgment document, the marker 1 and marker 2 are traversed line by line in each paragraph, without missing any location where the markers may exist in the document.

202. Extract a judgment paragraph between the marker 1 and the marker 2, the judgment paragraph involving a judgment decision.

Similar to Step 201, the marker 1 is a phrase ‘decided as follows’, ‘decision as follows’ or a variation thereof, and the marker 2 is a phrase ‘acceptance fee’ or a variation thereof. The marker 1 and the marker 2 appear in pair in the judgment document, if there are more than one pair of markers 1 and 2, a paragraph between the last pair of markers 1 and 2 is extracted to be used as judgment paragraph.

The judgment paragraph between the last pair of markers 1 and 2 involves a judgment decision. The section from the marker 1 to the marker 2 is the judgment paragraph. The marker 1 and the marker 2 appear in pair.

A judgment document, based on the number of trials, may be divided into a judgment document of first instance, a judgment document of second instance, and the like. In a judgment document of second instance, a decision of first instance is first recorded, then the second instance process is described, and finally a decision of second instance is recorded. In a judgment document of third instance, decisions of first and second instances are recorded, then the third instance process is described, and finally a decision of third instance is recorded. In a judgment document, a decision that appears at last is the final decision of the current trial. A decision corresponds to a pair of markers 1 and 2, and a paragraph between the last pair of markers 1 and 2 in a judgment document is used as a desired paragraph for decision determination, named as a judgment paragraph.

203. In the judgment paragraph, look up a lost-lawsuit related keyword within a preset character range posterior to the marker 1.

The method in this step is similar to that in Step 102 of FIG. 1, and not described in detail.

204a. If the lost-lawsuit related keyword is found, determine the decision as losing the case.

The method in this step is similar to that in Step 104 of FIG. 1, and not described in detail.

204b. If the lost-lawsuit related keyword is found, a marker 3 is looked up in the judgment paragraph, the marker 3 being a word ‘divorce’.

If the lost-lawsuit related keyword is not found, the determination is continued to judge whether a decision in the judgment document is losing the case. If the lost-lawsuit related keyword is found within a preset character range posterior to the marker 1, a marker ‘divorce’ is looked up in the judgment paragraph extracted in Step 201. For ‘divorce cases’ in civil actions, the expression of decision may be different from that of other civil cases. Thus, if the lost-lawsuit related keyword is not found, a marker ‘divorce’ needs to be looked up, and if the judgment document carries a decision of a divorce case, the looking-up is continued to determine a decision of judgment.

205b. If the marker 3 is found, look up a marker 4 in a sentence or paragraph containing the marker 3, the marker 4 being a phrase ‘not support’ or a variation thereof.

If the marker 3 is found, the judgment document is determined to carry a decision of divorce case. The marker 4 is looked up in a sentence or paragraph containing the marker 3, the separator for sentences includes but not limited to a full point, a semicolon, an exclamation point, etc., and the separator for paragraphs is a line break.

206b. If the marker 4 is found, determine the decision as losing the case.

If the marker 4 is found in Step 205b, the decision is determined as losing the case.

The phrases ‘divorce’ and ‘not support’ have substantially the same meaning as the lost-lawsuit related keywords ‘prohibit’ and ‘reject’. In order to avoid error determination on judgment decisions in the case of these special expressions, a procedure of determining a divorce case is added during the determination of a decision in a judgment document, to improve the accuracy of determining whether the decision is losing the case.

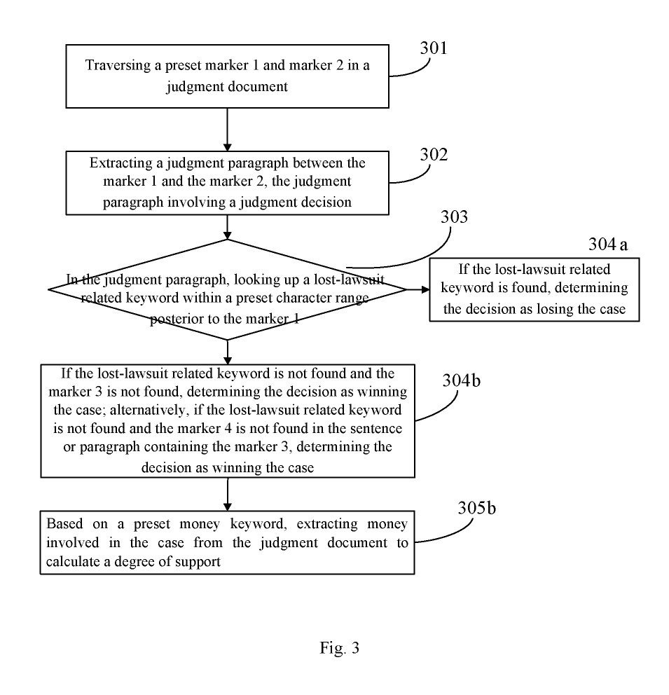

Further, as a detailed and modified mode of the method of FIG. 1, another embodiment of the invention also provides a method for automatically determining a decision in a judgment document, shown in FIG. 3, and the method comprises:

301. Traverse a preset marker 1 and marker 2 in the judgment document.

The marker 1 and marker 2 are traversed in the judgment document in the form of an electronic text, to determine the locations of the marker 1 and marker 2. The marker 1 is a phrase ‘decided as follows’, ‘decision as follows’ or a variation thereof, and the marker 2 is a phrase ‘acceptance fee’ or a variation thereof. In the judgment document, the marker 1 and marker 2 are traversed line by line in each paragraph, without missing any location where the markers may exist in the document.

302. Extract a judgment paragraph between the marker 1 and the marker 2, the judgment paragraph involving a judgment decision.

Similar to Step 201, the marker 1 is a phrase ‘decided as follows’, ‘decision as follows’ or a variation thereof, and the marker 2 is a phrase ‘acceptance fee’ or a variation thereof. The marker 1 and the marker 2 appear in pair in the judgment document, if there are more than one pair of markers 1 and 2, a paragraph between the last pair of markers 1 and 2 is extracted to be used as the judgment paragraph.

303. In the judgment paragraph, look up a lost-lawsuit related keyword within a preset character range posterior to the marker 1.

The method in this step is similar to that in Step 103 of FIG. 1, and not described in detail.

304a. If the lost-lawsuit related keyword is found, determine the decision as losing the case.

The method in this step is similar to that in Step 103 of FIG. 1, and not described in detail.

304b. If the lost-lawsuit related keyword is not found and the marker 3 is not found, determine the decision as winning the case. Alternatively, if the lost-lawsuit related keyword is not found and the marker 4 is not found in a sentence or paragraph containing the marker 3, determine the decision as winning the case.

The marker 3 is a phrase ‘divorce’, and if the marker of divorcement is not found, the decision in the judgment document is not for a divorce case. For a judgment document of divorce cases, if the lost-lawsuit related keyword is not found, the decision is determined as wining the case.

If a sentence or paragraph contains the marker 3, indicating that a phrase ‘divorce’ is recorded in the judgment document, the judgment document is prepared for a divorce case. If the marker 4 ‘not support’ or a variation thereof is not found in the judgment paragraph of the judgment document of a divorce case, and the lost-lawsuit related keyword is not found, the decision is determined as winning the case.

If the decision is determined as winning the case, the lost-lawsuit related keyword is looked up in other sections beyond the preset character range in the judgment paragraph. If the lost-lawsuit related keyword is found in other sections beyond the preset character range in the judgment paragraph, the decision of judgment is determined as partially winning the case.

In a judgment document that is determined as winning the case, the decision of partially winning the case is determined. The term ‘partially winning the case’ refers to the factor that a claim made by a plaintiff is not fully supported. For the claim that is not supported, a lost-lawsuit related keyword is used for negation.

305. Based on a preset money keyword, extract money involved in the case in the judgment document to calculate a degree of support.

If the decision is wining the case, money involved in the case is extracted based on the particular content of judgment. When money involved is extracted, the corresponding data is converted based on the money keyword. The money keyword involves the capital and ordinary forms of Chinese number ‘one’, quantity units ‘millions ‘and ‘a hundred million’, and relationship of deductible money ‘compensate’ and ‘advance’. The description of money corresponding to money keywords is converted into positive and negative Arabic numerals, to facilitate the processing of money data.

In the extracted section of money involved in a case, money supported by a court is selected to calculate the total money supported by the court. From the extracted section of money involved in the case, money not supported by the court is selected to calculate the total money not supported by the court. The sum of money supported by the court and money not supported by the court is equal to the total money involved in the case. The degree of support is finally calculated, which is the product of dividing money supported by the court by the total money involved in the case.

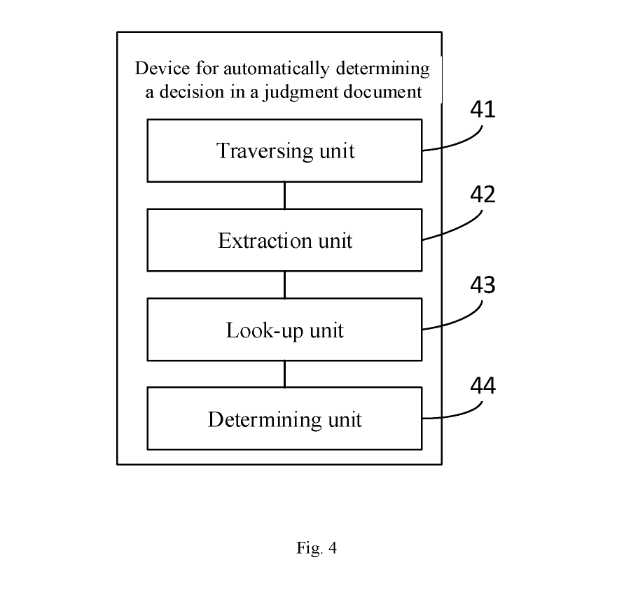

Further, for implementing the method of FIG. 1 to FIG. 3, another embodiment of the invention also provides a device for automatically determining a decision in a judgment document. The device embodiments correspond to the foregoing method embodiments, for easy reading, the device embodiments are not described in detail to the description of the foregoing method embodiments, but it should be noted that the device embodiments encompass all content corresponding to the foregoing method embodiments. As shown in FIG. 4, the device comprises a traversing unit 41, an extraction unit 42, a look-up unit 43 and a determining unit 44. Wherein,

the traversing unit 41 is used for traversing a preset marker 1 and marker 2 in the judgment document, the marker 1 being a phrase ‘decided as follows’, ‘decision as follows’ or a variation thereof, and the marker 2 being a phrase ‘acceptance fee’ or a variation thereof;

the extraction unit 42 is used for extracting a judgment paragraph between the marker 1 and the marker 2, the judgment paragraph involving a judgment decision;

the look-up unit 43 is used for looking up a lost-lawsuit related keyword within a preset character range posterior to the marker 1 in the judgment paragraph extracted by the extraction unit 42, the lost-lawsuit related keyword involving a word ‘reject’, ‘prohibit’ or a variation thereof;

and the determining unit 44 is used for determining the decision as losing the case if the lost-lawsuit related keyword is found by the look-up unit 43.

Further, the look-up unit 43 is used for looking up a marker 3 in the judgment paragraph if the lost-lawsuit related keyword is not found, the marker 3 being a word ‘divorce’;

the look-up unit 43 is further used for looking up a marker 4 in a sentence or paragraph containing the marker 3 if the marker 3 is found, the marker 4 being a phrase ‘not support’ or a variation thereof;

and the determining unit 44 is used for determining the decision as losing the case if the marker 4 is found by the look-up unit 43.

Further, the determining unit 44 is further used for determining the decision as winning the case if the lost-lawsuit related keyword is not found by the look-up unit and the marker 3 is not found; alternatively,

the determining unit 44 is further used for determining the decision as winning the case if the lost-lawsuit related keyword is not found by the look-up unit and the marker 4 is not found in a sentence or paragraph containing the marker 3.

Further, the look-up unit 43 is used for looking up the lost-lawsuit related keyword in other sections beyond the preset character range in the judgment paragraph if the decision is determined as winning the case;

the look-up unit 43 is further used for determining the decision as partially winning the case if the lost-lawsuit related keyword is found in other sections beyond the preset character range by the look-up unit.

Further, the marker 1 and the marker 2 obtained by traversing via the traversing unit appear in pair in the judgment document;

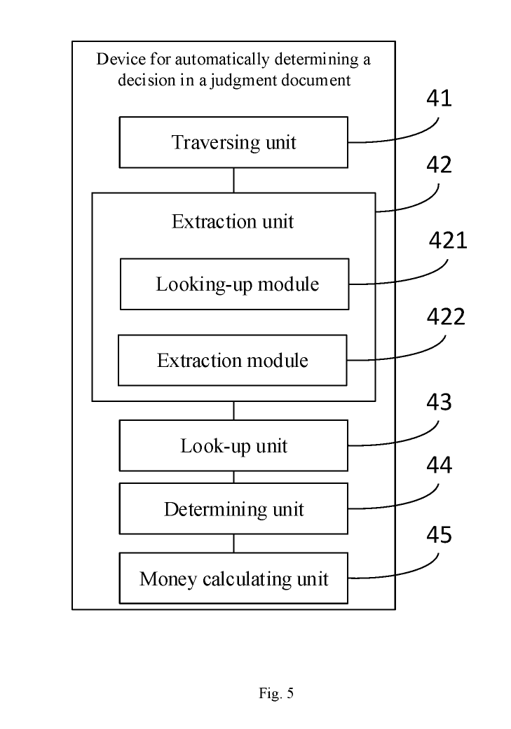

The extraction unit 42, as shown in FIG. 5, comprises:

a looking-up module 421, for looking up the last pair of markers 1 and 2 in the judgment document;

an extraction module 422, for extracting a paragraph between the last pair of markers 1 and 2 found by the looking-up module 421.

Further, as shown in FIG. 5, the device also comprises:

a money calculating unit 45, for after the decision is determined by the determining unit as wining the case, calculating the degree of support from money involved in a case that is extracted from the document based on a preset money keyword.

The device for automatically determining a decision in a judgment document, provided by the embodiments of the invention, can traverse the preset markers in the judgment document, extract the paragraph related to the decision, then look up the lost-lawsuit related keyword and finally determine whether the decision is losing the case. Compared with the prior art, the embodiments of the invention can automatically determine judgment decisions, to reduce manual workload, save labor and improve the efficiency of extracting judgment decisions.

The device for automatically determining a decision in a judgment document comprises a processor and a memory unit, and the traversing unit 41, the extraction unit 42, the look-up unit 43 and the determining unit 44 are all stored as program units in the memory unit, and the program units stored in the memory unit are executed by the processor to exert the corresponding functions.

The processor comprises a core for calling a corresponding program unit in the memory unit. The number of the core may be one or more, and the parameters of the core are adjusted to solve the problem of low efficiency of manually extracting a decision of judgment.

The memory unit may comprise non-permanent memory, random access memory and/or nonvolatile memory on computer-readable media, for example, read only memory (ROM) or flash RAM, and the memory unit comprises at least one memory chip.

The present application also provides a computer program product suitable for performing initialization of program codes executing the following method steps when executed on data processing equipment: traversing a preset marker 1 and marker 2 in a judgment document, the marker 1 being a phrase ‘decided as follows’, ‘decision as follows’ or a variation thereof, and the marker 2 being a phrase ‘acceptance fee’ or a variation thereof; extracting a judgment paragraph between the marker 1 and the marker 2, the judgment paragraph involving a judgment decision, extracting a judgment paragraph between the marker 1 and the marker 2, the judgment paragraph involving a judgment decision, if the lost-lawsuit related keyword is found, determining the decision as losing the case; If the lost-lawsuit related keyword is not found, looking up a marker 3 in the judgment paragraph, the marker 3 being a word ‘divorce’; if the marker 3 is found, looking up a marker 4 in a sentence or paragraph containing the marker 3, the marker 4 being a phrase ‘not support’ or a variation thereof; if the marker 4 is found, determining the decision as losing the case.

It will be understood for those skilled in the art that the embodiments of the present application may be provided as a method, a system or a computer program product. Therefore, the present application may be implemented in the form of an entire hardware embodiment, an entire software embodiment, or an embodiment combining software and hardware. Further, the present application may be implemented in the form of a computer program product executed on one or more computer-usable storage media on which computer-usable program codes are carried, for example but not limited to disk memory, CD-ROM, optical memory and the like.

The present application is described with reference to a flowchart and/or block diagram of a method, an apparatus (system) and a computer program product according to the embodiments of the present application. It will be understood that each procedure and/or block in the flowchart and/or block diagram and a combination of procedures and/or blocks in the flowchart and/or block diagram may be implemented by computer program instructions. These computer program instructions may be provided to a processor of a general purpose computer, a special purpose computer, an embedded processor or other programmable data processing equipment to produce a machine, so that the instructions executed by the processor of the computer or other programmable data processing equipment produce a device for implementing the functions specified in one or more procedures of the flowchart and/or one or more blocks in the block diagram.

These computer program instructions may also be stored in a computer-readable memory that can direct a computer or other programmable data processing equipment to work in a particular manner, so that the instructions stored in the computer-readable memory produce a manufacturing article including an instruction device, the instruction device implements the functions specified in one or more procedures of the flowchart and/or one or more blocks of the block diagrams.

These computer program instructions may also be loaded onto a computer or other programmable data processing equipment to enable a series of operating steps to be performed on the computer or other programmable equipment and thus to produce computer-implemented processing, so that the instructions executed on the computer or other programmable equipment provide the steps for implementing the functions specified in one or more flows of the flowchart and/or one or more blocks of the block diagrams.

In a typical configuration, the computing device comprises one or more processors (CPUs), input/output interfaces, a network interface and a memory unit.

The memory unit may comprise non-permanent memory, random access memory and/or nonvolatile memory on computer-readable media, for example, read only memory (ROM) or flash RAM. The memory unit is an example of computer-readable media.

Computer-readable media comprises permanent and non-permanent, mobile and non-mobile media, and may implement the storage of information by any method or technology. The information may be computer-readable instructions, data structures, modules of programs, or other data. An example of computer storage media includes but not limited to a phase change random access memory (PRAM), a static random access memory (SRAM), a dynamic random access memory (DRAM), other types of random access memory (RAM), read only memory (ROM), electrically erasable programmable read-only memory (EEPROM), flash memory or other memory technologies, CD-ROM, DVD, or other optical memory, cassette type tapes, tape type disk memory or other mantic memory, or any other non-transmission media, for storing information accessible by the computing device. As defined herein, the computer-readable media do not include transitory media such as modulated data signals and carriers.

The foregoing description is merely illustrative of the embodiments of the present application and not intended to limit the present application. It will be evident for those skilled in the art that various changes and variations may be made to this application. Any modifications, equivalent replacements and improvements made within the spirit and principle of the present application should fall into the scope defined by the claims of the present application.

1. A method for automatically determining a decision in a judgment document, characterized in that the method comprises:
traversing a preset marker 1 and marker 2 in the judgment document, the marker 1 being a phrase ‘decided as follows’, ‘decision as follows’ or a variation thereof, and the marker 2 being a phrase ‘acceptance fee’ or a variation thereof;
extracting a judgment paragraph between the marker 1 and the marker 2, the judgment paragraph involving a judgment decision;
in the judgment paragraph, looking up a lost-lawsuit related keyword within a preset character range posterior to the marker 1, the lost-lawsuit related keyword involving a word ‘reject’, ‘prohibit’ or a variation thereof;
if the lost-lawsuit related keyword is found, determining the decision as losing the case.

2. The method according to claim 1, characterized in that the method further comprises:
if the lost-lawsuit related keyword is not found, looking up a marker 3 in the judgment paragraph, the marker 3 being a word ‘divorce’;
if the marker 3 is found, looking up a marker 4 in a sentence or paragraph containing the marker 3, the marker 4 being a phrase ‘not support’ or a variation thereof;
if the marker 4 is found, determining the decision as losing the case.

3. The method according to claim 2, characterized in that the method further comprises:
if the lost-lawsuit related keyword is not found and the marker 3 is not found, determining the decision as winning the case; alternatively,
if the lost-lawsuit related keyword is not found and the marker 4 is not found in the sentence or paragraph containing the marker 3, determining the decision as winning the case.

4. The method according to claim 3, characterized in that the method further comprises:
if the decision is determined as winning the case, looking up the lost-lawsuit related keyword in other sections beyond the preset character range in the judgment paragraph;
if the lost-lawsuit related keyword is found in other sections beyond the preset character range, determining the decision as partially winning the case.

5. The method according to claim 1, characterized in that the marker 1 and the marker 2 appear in pair in the judgment document;
the extracting the judgment paragraph between the marker 1 and the marker 2 comprises:
looking up the last pair of markers 1 and 2 in the judgment document;
extracting the judgment paragraph between the last pair of markers 1 and 2.

6. The method according to claim 3, characterized in that after the decision is determined as winning the case, the method further comprises:
based on a preset money keyword, extracting money involved in the case from the judgment document to calculate a degree of support.

7. A device for automatically determining a decision in a judgment document, characterized in that the device comprises:
a traversing unit, used for traversing a preset marker 1 and marker 2 in the judgment document, the marker 1 being a phrase ‘decided as follows’, ‘decision as follows’ or a variation thereof, and the marker 2 being a phrase ‘acceptance fee’ or a variation thereof;
an extraction unit, used for extracting a judgment paragraph between the marker 1 and the marker 2, the judgment paragraph involving a judgment decision;
a look-up unit, used for looking up a lost-lawsuit related keyword within a preset character range posterior to the marker 1 in the judgment paragraph extracted by the extraction unit, the lost-lawsuit related keyword involving a word ‘reject’, ‘prohibit’ or a variation thereof;
and a determining unit, used for determining the decision as losing the case if the lost-lawsuit related keyword is found by the look-up unit.

8. The device according to claim 7, characterized in that,
the traversing unit is used for looking up a marker 3 in the judgment paragraph if the lost-lawsuit related keyword is not found, the marker 3 being a word ‘divorce’;
the look-up unit is used for looking up a marker 4 in a sentence or paragraph containing the marker 3 if the marker 3 is found, the marker 4 being a phrase ‘not support’ or a variation thereof;
and the determining unit is used for determining the decision as losing the case if the marker 4 is found.

9. The device according to claim 8, characterized in that,
the determining unit is further used for determining the decision as winning the case if the lost-lawsuit related keyword is not found by the look-up unit and the marker 3 is not found; alternatively,
the determining unit is further used for determining the decision as winning the case if the lost-lawsuit related keyword is not found by the look-up unit and the marker 4 is not found in the sentence or paragraph containing the marker 3.

10. The device according to claim 9, characterized in that,
the look-up unit is further used for looking up the lost-lawsuit related keyword in other sections beyond the preset character range in the judgment paragraph if the decision is determined as winning the case;
and the determining unit is further used for determining the decision as partially winning the case if the lost-lawsuit related keyword is found in other sections beyond the preset character range.
